(19) United States
(12) Patent Application Publication
(10) Pub. No.: US 2017/0177575 A1
(43) Pub. Date: Jun. 22, 2017

(54) PROCESSING TRANSACTIONS INVOLVING AN EXCHANGE OF AN ELECTRONIC DOCUMENT

(71) Applicant: Amadeus S.A.S., Biot (FR)

(72) Inventors: Cedric FLORIMOND, Vallauris (FR); Nicolas BINOIS, Golfe-Juan (FR); Linda BOUDIA MEZRAG, Antibes (FR); Daniel SASTRE GARCIA, Nice (FR); Mohammed HILMY, Antibes (FR); Mohamed Imad EL MOUDDEN, Antibes (FR); Romuald CARRE, Cagnes-sur-mer (FR)

(21) Appl. No.: 14/971,633

(22) Filed: Dec. 16, 2015

(51) Int. Cl. G06F 17/30; G06Q 20/22

(52) U.S. Cl. CPC G06F 17/3053; G06Q 20/22

(57) ABSTRACT

Systems, methods, and computer program products for processing transactions involving an exchange of an electronic document, such as a ticket redeemable for a travel service. Data defining related transactions is stored in a transaction database. In response to detecting the occurrence of a transaction involving a tracked document, a transaction history of the document is retrieved from the transaction database. A plurality of payment events is extracted from the transaction history and filtered by document type and form of payment to determine a set of payment events with forms of payment that are refund-eligible. The refund-eligible forms of payment are aggregated, and the aggregated forms of payment ranked. A residual amount associated with the exchange is reconciled across the ranked aggregated forms of payment by one or more payment events. The payment events are then added to the transaction history of the tracked document in the database.

### BACKGROUND

The invention generally relates to computers and computer systems and, in particular, to methods, systems, and computer program products that process transactions involving documents redeemable for a travel service.

In the travel industry, documents redeemable for travel services (e.g., electronic tickets for travel by air, rail, car, or ship) may be purchased through an indirect seller, such as a travel agency, directly from the provider of the travel service, or through some other merchant. The merchant will typically check for available flights or other travel services that satisfy a traveler's travel plans and, once matching services are found, book the services for the traveler and collect payment. Payment may be collected in several ways, such as by charging a personal or credit card account of the traveler, redeeming reward points (e.g., frequent flier miles), redeeming a voucher, receiving currency from the traveler, or by any other suitable form of payment.

In some cases, the traveler may wish to exchange a purchased ticket for a new ticket. If the new ticket is more expensive than the old ticket, the traveler will normally be required to pay the difference. The traveler may also be required to pay a penalty, depending on any constraints imposed on redemption of the old ticket by the merchant or travel service provider. If the new ticket is less expensive than the old ticket, the difference may be refunded, minus any penalties. Additional payments may be collected in a similar manner as with the purchase of the original ticket. Refunds may take the form of credits to one or more accounts, issuance of a voucher, by cash payment directly to the traveler, or any other form of payment.

In some cases, tickets may be exchanged multiple times, with different forms of payment and governing rules applying for each transaction. This can lead to ticket transaction histories that are quite complex. Because the forms of payment used to purchase each ticket and the rules governing the sale of the ticket may impact how the ticket should be refunded, it may be difficult to determine how much to refund the traveler, and the forms of payment that should be used for tickets having a complex history. This can result in one or more of the traveler, the merchant, an intervening bank, or the carrier receiving an amount or form of payment that differs from what they are entitled to receive.

Thus, improved systems, methods, and computer program products for processing transactions are needed to improve the accuracy of ticket refunds and exchanges.

### SUMMARY

In an embodiment of the invention, a system for processing transaction requests is provided. The system includes one or more processors and a memory coupled to the one or more processors. The memory stores data comprising a database and program code that, when executed by the one or more processors, causes the system to, in response to receiving a transaction request for a document, retrieve, from the database, a transaction history for the document comprising a plurality of payment events each associated with a form of payment. The system filters the plurality of payment events to determine a set of payment events associated with forms of payment that are refund-eligible, and aggregates the forms of payment associated with the set of payment events to produce one or more aggregated forms of payment. The system then ranks the one or more aggregated forms of payment based on a refund hierarchy, selects an aggregated form of payment from the one or more aggregated forms of payment based on rank, and determines an amount to be refunded from the aggregated form of payment based at least in part on a residual value of the document.

In another embodiment of the invention, a method of processing the transaction request is provided. The method includes, in response to receiving the transaction request, retrieving the transaction history for the document from the database and filtering the plurality of payment events to determine the set of payment events associated with the forms of payment that are refund-eligible. The method further includes aggregating the forms of payment associated with the set of payment events to produce the one or more aggregated forms of payment, ranking the one or more aggregated forms of payment based on the refund hierarchy, selecting the aggregated form of payment from the one or more aggregated forms of payment based on rank, and determining the amount to be refunded from the aggregated form of payment based at least in part on the residual value of the document.

In another embodiment of the invention, a computer program product is provided that includes a non-transitory computer-readable storage medium including program code. The program code is configured, when executed by the one or more processors, to cause the one or more processors to, in response to receiving the transaction request, retrieve the transaction history for the document from the database. The program code further causes the one or more processors to filter the plurality of payment events to determine the set of payment events associated with the forms of payment that are refund-eligible, and aggregate the forms of payment associated with the set of payment events to produce the one or more aggregated forms of payment. The program code further causes the one or more processors to rank the one or more aggregated forms of payment based on the refund hierarchy, select the aggregated form of payment from the one or more aggregated forms of payment based on rank, and determine the amount to be refunded from the aggregated form of payment based at least in part on the residual value of the document.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including a payment system in communication with a transaction database.

FIG. 2 is a diagrammatic view of an exemplary computer for providing the operating environment of FIG. 1.

FIG. 3 is a diagrammatic view of the payment system depicting a form of payment module and a settlement module.

FIG. 4 is a diagrammatic view of a transaction history tree depicting transactions involving the exchange of electronic documents and the occurrence of payment events.

FIG. 5 is a diagrammatic view of a document history table and a FOP table that may be used to track the electronic documents and payment events of FIG. 4.

FIG. 6 is a flow-chart illustrating a process that may be executed by the payment system of FIG. 1 to process a transaction request.

FIG. 7 is a diagrammatic view of a transaction history tree depicting transactions involving the exchange of electronic documents and payment events after a document has been refunded.

### DETAILED DESCRIPTION

Embodiments of the invention are directed to systems, methods, and computer program products for managing transactions involving the exchange or refund of an electronic document, such as a ticket. The document may have been issued to a traveler for the purposes of obtaining a travel-related service, such as a flight, a meal, a hotel, a rental car, or any other service. Embodiments of the invention may be implemented on a transaction processing system comprising one or more networked computers or servers. The networked computers may include a payment system in communication with a transaction database, and may provide processing and database functions for travel-related systems and modules that manage the transactions.

The payment system may work cooperatively with the transaction database to enable exchanging or refunding of a document that has been exchanged one or more times, with each exchange involving one or more forms of payment, or having a transaction history that involves one or more non-refundable payments or non-refundable documents. The transaction database may enable the payment system to take into account constraints on refunding or exchanging the document based on the types of documents comprising the transaction history and the forms of payment used to pay for the documents. The transaction database may also enable the payment system to enforce policies specific to a travel service provider, constraints on the forms of payment, constraints based on industry standards, and constraints based on the transaction history of the document. Embodiments of the invention may thereby determine which forms of payment to refund and for what amounts. These refunds may be implemented automatically, or propose to a system user for validation. The transaction database may also enable reservation systems to book services in exchange for documents. This ability to price document exchanges and refunds may enable web-sites and other consumer interfaces that allow travelers to revise booked trips without the help of a travel agent.

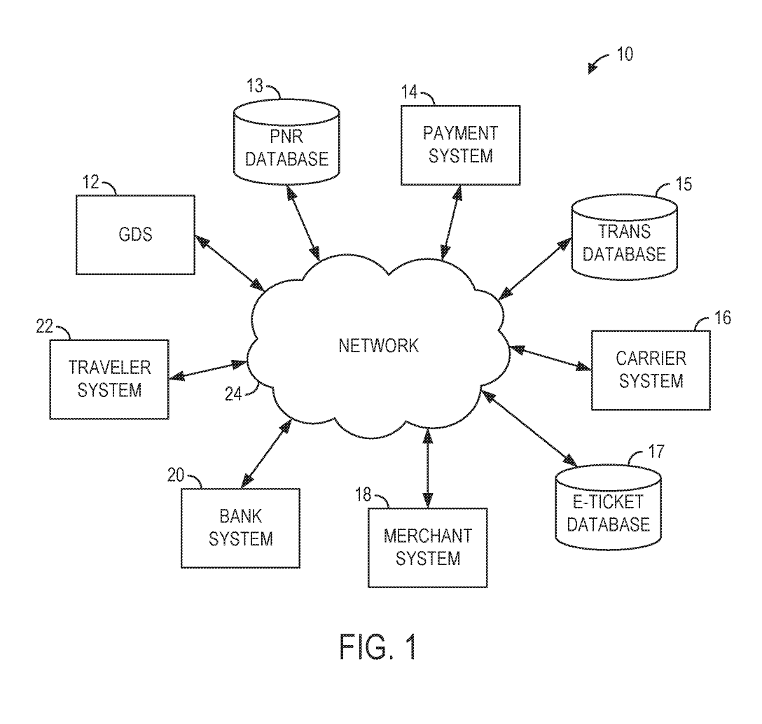

Referring now to FIG. 1, an operating environment 10 for the transaction processing system in accordance with an embodiment of the invention may include a Global Distribution System (GDS) 12, a Passenger Name Record (PNR) database 13, a payment system 14, a transaction database 15, one or more travel service provider systems, such as carrier system 16, an electronic, or e-ticket database 17, one or more indirect seller systems, such as merchant system 18, a bank system 20, and a traveler system 22. Each of the GDS 12, PNR database 13, payment system 14, transaction database 15, carrier system 16, e-ticket database 17, merchant system 18, bank system 20, and traveler system 22 may communicate through a network 24. The network 24 may include one or more private or public networks (e.g., the Internet) that enable the exchange of data.

The GDS 12 may be configured to facilitate communication between the carrier system 16 and merchant system 18 by enabling travel agents, validating carriers, or other indirect sellers to book reservations on the carrier system 16 via the GDS 12. The GDS 12 may maintain links to a plurality of carrier systems via the network 24 that enables the GDS 12 to route reservation requests from the validating carrier or travel agency to a corresponding operating carrier. The carrier system 16 and merchant system 18 may thereby book flights on multiple airlines via a single connection to the GDS 12.

In response to the traveler booking a travel service, the GDS 12 may receive and store a Passenger Name Record (PNR) in the PNR database 13. The PNR may comprise one or more reservation records that contain itinerary and traveler information associated with one or more booked reservations. Each PNR may include data defining an itinerary for a particular trip, passenger, or group of passengers. The defined itinerary may include travel services from multiple travel service providers. To facilitate locating the PNR in the PNR database 13, a record locator or other suitable identifier may be associated with the PNR.

The payment system may 14 may be configured to store and retrieve data describing payment events related to transactions involving travel services, such as the sale of a ticket for a flight. In response to the occurrence of a payment event associated with a tracked document (e.g., the ticket), one or more of the systems involved in the payment event may request historical data for previous payment events relating to the tracked document from the payment system 14. The request may include data that identifies the tracked document as well as details relating to the current payment event. In response to receiving the request, the payment system 14 may search the transaction database 15 for data relating to previous payment events involving the tracked document, and transmit the search results to the requesting system. The payment system 14 may also receive data relating to a current payment event, and update records in the transaction database 15 to document the current payment event.

Payment events related to tracked documents may be detected by the payment system 14 based on payment event rules. If a payment event for a tracked document matches the payment event rules, the payment system 14 may notify the transaction database 15 that a new payment event has been detected for the tracked document. Each transaction may relate to the purchase or exchange of a document, and may include one or more payment events. The total amount of the payment events associated with a transaction may provide an amount required to cover a total payment for the transaction.

The transaction database 15 may store and manage data relating to transactions involving the sale, exchange, and refunding of documents for travel services, such as a ticket for a flight. This data may include data defining purchases, prices, forms of payment, penalties, residual values, credits, or any other data that defines a transaction history. The data may be stored in a plurality of records managed by the transaction database 15. The transaction database 15 may also include one or more tables that define associations between records. These tables may enable the transaction database 15 to search for and retrieve data relating to the transaction history of particular document, such as a ticket.

The carrier system 16 may include a Computer Reservation System (CRS) that enables the GDS 12 or merchant system 18 to reserve and pay for travel services. The carrier system 16 may also interact with other carrier systems (not shown), either directly or through the GDS 12, to enable a validating carrier to sell tickets for seats provided by the operating carrier. The operating carrier may then bill the validating carrier for the services provided. The carrier system may also include a fare engine that prices travel services. The fare engine may determine the price of a travel service as well as penalties for exchanging a document based on rules relating to the pricing of travel services.

The carrier system 16 may also include an Electronic Ticketing System (ETS) configured to maintain records of the purchase, use, and exchange of documents issued by a corresponding carrier. To this end, the ETS may access the PNR database 13 and/or e-ticket database 17 as needed to track the status of documents issued by the carrier. Data defining and tracking use of a document may be stored, at least in part, in the form of a PNR in the PNR database 13, and/or as one or more documents in the e-ticket database 17.

The merchant system 18 may be configured to exchange data with the payment system 14 and one or more bank systems, such as bank system 20, to execute a transaction resulting in a payment event. In the case of a purchase paid for at least in part by a credit or debit card, at the time of the transaction, the merchant system 18 may transmit an authorization request to an issuing bank system. In response to receiving the authorization request, the issuing bank system may verify the credit card account is valid, and that the account has sufficient funds to cover the amount of the transaction. The issuing bank system may then transmit an authorization response to the merchant system 18 indicating that the transaction has been approved, declined, or that more information is required.

Purchasing a service through the carrier system 16, merchant system 18, or other suitable system, may involve pricing, booking, and issuance of the document. By way of example, the service defined by the document may be priced by the ticketing office with the help of the fare engine. The fare engine may determine a fare for the service by calculating the fare for each of one or more priceable units that satisfy the itinerary of the ticket, and summing these fares. The resulting document may comprise one or more electronic coupons stored in the e-ticket database 17, with each coupon corresponding to one of the segments or services of the trip. The itinerary of the document may define the segments for which the document can be used to obtain a boarding pass, and/or other services that comprise the trip. Each segment defined by the itinerary may comprise one or more sequential legs, each leg connecting a scheduled departure station to a scheduled arrival station.

Booking the reservation may include checking the provider inventory for availability of the service, e.g., seat availability on the segments comprising the itinerary. This check may include sending a reservation request from the merchant system 18 to the GDS 12. The GDS 12 may in turn query a corresponding carrier system 16 for availability of the services defined by the electronic document. If the requested services are available, the services may be booked, and the carrier inventory decreased to reflect the booking. In response to the traveler approving the transaction, the traveler's account may be billed for the price of the services.

Once the transaction is complete, the merchant system 18 may transmit data characterizing the transaction to an acquiring bank system. The acquiring bank system may then deposit funds into an account of the merchant, and recover funds from corresponding issuing banks of the credit cards, debit cards, or any other forms of payment used to purchase travel services.

The traveler system 22 may comprise a desktop computer, laptop computer, tablet computer, smart phone, or any other suitable computing device. The traveler may use the traveler system 22 to search for and book travel services by accessing the GDS 12, carrier system 16, merchant system 18, or any other suitable system though the network 24. For example, the traveler may launch a browser application, and use the browser application to search for travel services on a web-site provided by a travel services provider or reseller. The traveler may then book a selected travel service by entering payment information into the web-site.

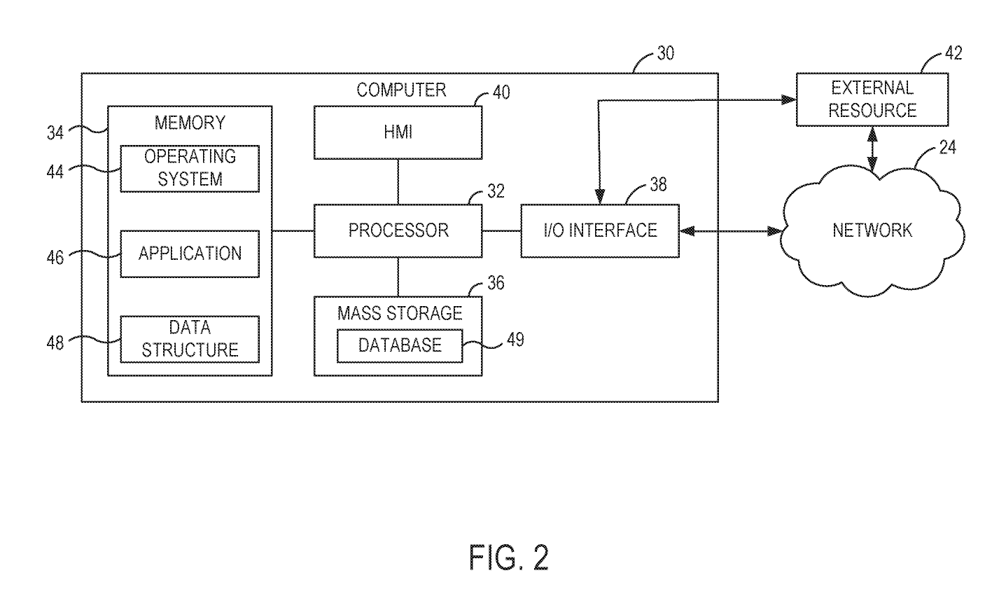

Referring now to FIG. 2, the GDS 12, PNR database 13, payment system 14, transaction database 15, carrier system 16, e-ticket database 17, merchant system 18, bank system 20, and traveler system 22 of operating environment 10 may be implemented on one or more computer devices or systems, such as exemplary computer 30. The computer 30 may include a processor 32, a memory 34, a mass storage memory device 36, an input/output (I/O) interface 38, and a Human Machine Interface (HMI) 40. The computer 30 may also be operatively coupled to one or more external resources 42 via the network 24 or I/O interface 38. External resources may include, but are not limited to, servers, databases, mass storage devices, peripheral devices, cloud-based network services, or any other suitable computer resource that may be used by the computer 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 36 may include data storage devices such as a hard drive, optical drive, tape drive, volatile or non-volatile solid state device, or any other device capable of storing information.

The processor 32 may operate under the control of an operating system 44 that resides in memory 34. The operating system 44 may manage computer resources so that computer program code embodied as one or more computer software applications, such as an application 46 residing in memory 34, may have instructions executed by the processor 32. In an alternative embodiment, the processor 32 may execute the application 46 directly, in which case the operating system 44 may be omitted. One or more data structures 48 may also reside in memory 34, and may be used by the processor 32, operating system 44, or application 46 to store or manipulate data.

The I/O interface 38 may provide a machine interface that operatively couples the processor 32 to other devices and systems, such as the network 24 or external resource 42. The application 46 may thereby work cooperatively with the network 24 or external resource 42 by communicating via the I/O interface 38 to provide the various features, functions, applications, processes, or modules comprising embodiments of the invention. The application 46 may also have program code that is executed by one or more external resources 42, or otherwise rely on functions or signals provided by other system or network components external to the computer 30. Indeed, given the nearly endless hardware and software configurations possible, persons having ordinary skill in the art will understand that embodiments of the invention may include applications that are located externally to the computer 30, distributed among multiple computers or other external resources 42, or provided by computing resources (hardware and software) that are provided as a service over the network 24, such as a cloud computing service.

The HMI 40 may be operatively coupled to the processor 32 of computer 30 in a known manner to allow a user to interact directly with the computer 30. The HMI 40 may include video or alphanumeric displays, a touch screen, a speaker, and any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

A database 49 may reside on the mass storage memory device 36, and may be used to collect and organize data used by the various systems and modules described herein. The database 49 may include data and supporting data structures that store and organize the data. In particular, the database 49 may be arranged with any database organization or structure including, but not limited to, a relational database, a hierarchical database, a network database, an object-oriented database, or combinations thereof. A database management system in the form of a computer software application executing as instructions on the processor 32 may be used to access the information or data stored in records of the database 49 in response to a query, where a query may be dynamically determined and executed by the operating system 44, other applications 46, or one or more modules. Although embodiments of the invention may be described herein using relational, hierarchical, network, object-oriented, or other database terminology in specific instances, persons having ordinary skill in the art will understand that embodiments of the invention may use any suitable database management model, and are not limited to any particular type of database.

When an old document is presented for a refund or in exchange for a new document, the party accepting the old document may need to determine a residual value of the old document and the forms of payment (e.g., cash, reimbursement of credit card account, voucher, online payment system, reward points, etc.) that may be used to return the residual value to the traveler. To determine the residual value and allowable forms of payment, the party accepting the old document may need to know the forms of payment used to pay for the old document, whether the forms of payment are refundable, and whether the old document was issued as part of a previous document exchange.

Other constraints that may affect the residual value and allowable forms of payment include constraints imposed on the document (e.g., certain payments, such as penalties, are non-refundable), policies of the carrier issuing the document (e.g., refund via credit cards is prioritized over refunding via cash, payment by frequent flyer miles cannot be refunded in cash), constraints based on the form of payment type (e.g., a bank transfer cannot be refunded automatically, vouchers are not refundable), constraints defined by industry standards, (e.g., imposing a maximum number (e.g., three) of forms of payment that can be used to refund a document), constraints based on the transaction history of the document (e.g., the forms of payment available to refund a document must have been used to pay for the document being refunded or for documents that were exchanged for the document being refunded). Form of payment types may include, but are not limited to, cash, credit cards, vouchers, and reward points (e.g., frequent flyer miles).

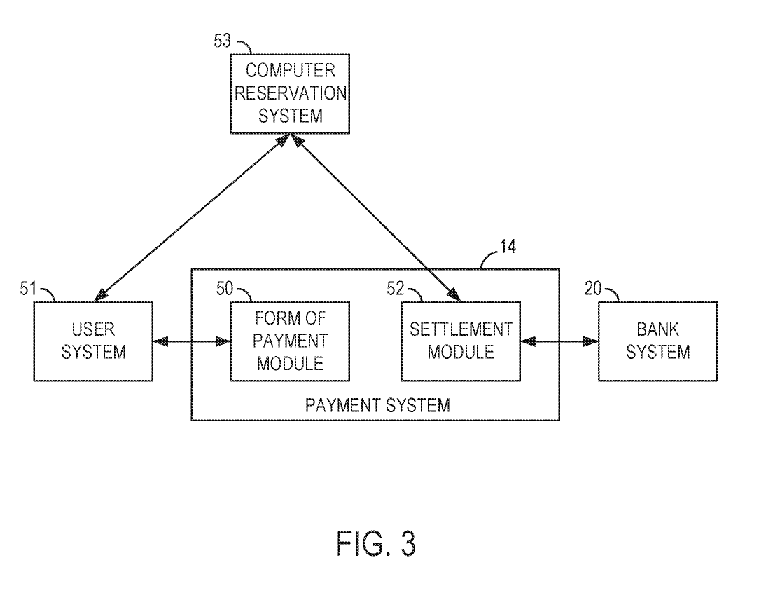

Referring now to FIG. 3, payment system 14 may include a form of payment module 50 in communication with a user system 51, and a settlement module 52 in communication with the bank system 20 and a computer reservation system 53. The user system 51 may comprise, for example, the merchant system 18 if the user is a travel agent, or the traveler system 22 if the user is the traveler. The computer reservation system 53 may be provided, for example, by the GDS 12 or carrier system 16.

To exchange a document, the user may access the computer reservation system 53 from the user system 51. The user may then open a document refund screen and select the document they wish to exchange or have refunded. The user system 51 may then communicate with the form of payment module 50 to determine the forms of payment that are eligible for refunding, and the amount that may be refunded to each eligible form of payment. In response to the user confirming the refund with the computer reservation system 53, the computer reservation system 53 may transmit a request to the settlement module 52 to refund the forms of payment. The settlement module may then communicate with the bank system 20 to implement the refund. The payment system 14 may thereby provide a link between banking and reservation systems by storing booking data from the computer reservation system 53 in the transaction database 15, and processing this booking data to provide one or more of the bank system 20, user system 51, or computer reservation system 53 with payment and refund data.

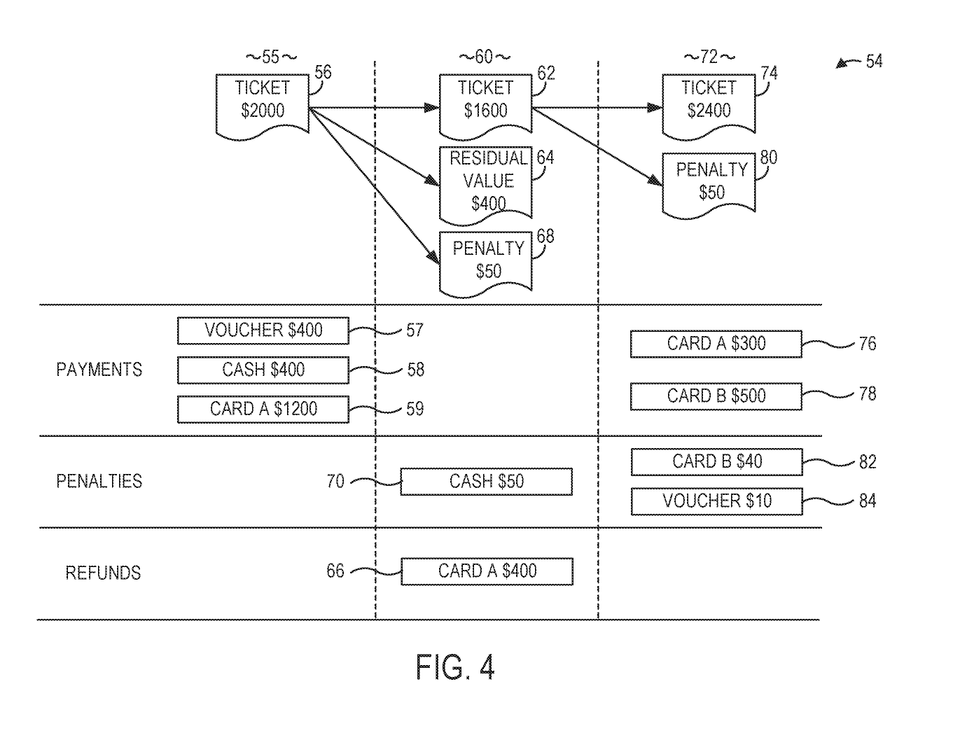

FIG. 4 presents a diagrammatic view of an exemplary transaction history tree 54 comprising a plurality of transactions involving tracked documents. Transaction 55 may represent the purchase of an original document for an agreed upon price, e.g., $2000. In response to the traveler purchasing the document, the ETS may store a document 56 in the e-ticket database 17. Each transaction may include one or more payment events. For example, as depicted by transaction 55, the payment for the document may be satisfied by multiple payment events 57-59. Payment event 57 may correspond to payment of a portion of the document price using one form of payment, e.g., a voucher for $400. Payment event 58 may correspond to payment of another portion of the document price using another form of payment, e.g., a cash payment of $400. Yet another payment event 59 may correspond to payment of a final portion of the document using yet another form of payment, e.g., a payment of $1,200 using credit card A.

Transaction 60 may represent an exchange of document 56 for a new document, which may cause the ETS to store document 62 in the e-ticket database 17. The new document 62 may have a different price (e.g., $1200) than the document 56 being exchanged. For example, as the depicted by transaction 60, the new document 62 may be less expensive than the old document 56. If the new document 62 is less expensive than the old document 56, a residual value document 64 may be generated in the e-ticket database 17. The residual value document 64 may reflect the value of the difference (e.g., $400) between the price of the old document 56 and the price of the new document 62. The residual value document 64 may be reconciled by a payment event 66 that refunds the residual amount to credit card A. The traveler may also incur a penalty for exchanging the document. If the traveler incurs a penalty, the ETS may store a penalty document 68 reflecting the cost of the penalty in the e-ticket database 17. The penalty may then be paid using a suitable form of payment, e.g., a cash payment of $50, thereby generating another payment event 70.

Transaction 72 may represent another document exchange. For example, the traveler may decide to upgrade to a better class, or add a destination, and exchange the currently held document 62 for a new, more expensive document 74. Exchanging one document for another more expensive document may trigger additional payment events to cover the difference (e.g., $800) between the old document 62 and the new document 74. For example, payment event 76 may correspond to the traveler paying one portion of the difference using one form of payment, e.g., a payment of $300 using credit card A. Payment event 78 may correspond to the traveler paying another portion of the difference using a different form of payment, e.g., a payment of $500 using credit card B.

The traveler may also incur another penalty, thereby triggering issuance of a penalty document 80 for the penalty amount, e.g., $50. Issuance of the penalty document 80 may result in additional payment events to cover the penalty, such as payment event 82 corresponding to payment of a portion of the penalty using one form of payment (e.g., a $40 charge to credit card B), and payment event 84 corresponding to payment of another portion of the penalty using another form of payment (e.g., a payment of $10 using a voucher).

In the event the traveler requests a refund of a document, the merchant will need to determine a residual value of the document, and how the residual value should be distributed to the traveler. This value may depend on both the transaction history of the document being refunded, and the polices of the merchant. For example, the merchant may have policies that prohibit refunding penalty documents, prohibit refunding payments made using vouchers, and/or prioritize crediting card accounts over paying out in cash.

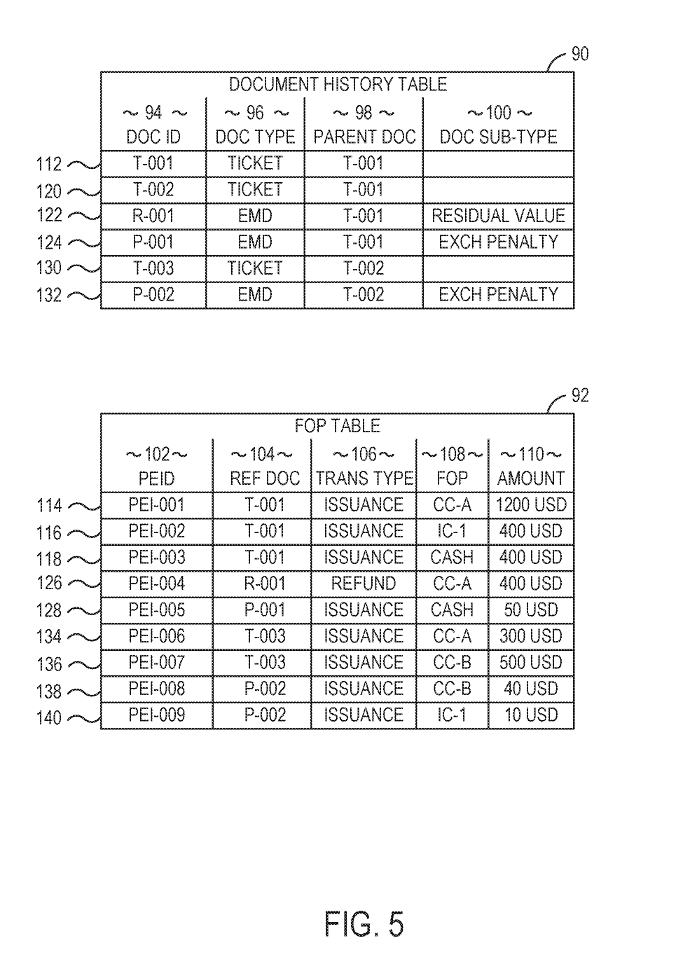

Referring now to FIG. 5, to facilitate document tracking, the transaction database 15 may include a document history table 90 and a Form Of Payment (FOP) table 92. The document history table 90 may store data defining relations between issued and exchanged documents. For example, when one or more earlier purchased documents are exchanged for one or more new documents, the document history table 90 may define the earlier documents as parents of the new documents. In any case, the number of documents being exchanged may be different than the number of new documents. For example, a plurality of documents may be exchanged for one new document, or one document may be exchanged for a plurality of new documents. Additional information stored by the document history table 90 may include a document type (e.g., electronic ticket or Electronic Miscellaneous Document (EMD)), and a document subtype (e.g., residual value or penalty). The FOP table 92 may maintain payment histories for each document. To this end, for each payment event, the FOP table 92 may store a payment record identifier, the identifier of the document associated with the payment event (i.e., the reference document), the type of payment (issuance or refund), the form of payment used, and the corresponding amount of the payment.

In an exemplary embodiment of the invention, the document history table 90 may include a column 94 for storing a document identifier for the tracked document, a column 96 for storing data defining the document type for the tracked document, a column 98 for storing a document identifier of a parent document of the tracked document, and a column 100 for storing data defining the document subtype for the tracked document. The FOP table 92 may include a column 102 for storing a payment event identifier for the tracked payment event, a column 104 for storing a reference document identifier that identifies the document associated with the tracked payment event, a column 106 for storing data defining the type of transaction associated with the tracked payment event, a column 108 for storing data defining the form of payment associated with the tracked payment event, and a column 110 for storing data defining the amount of payment associated with the form of payment. Each of the columns in the tables may be used to store data defining the corresponding information, or a record locator, identifier, or other pointer that can be used to identify database records containing the corresponding information.

When a document is issued, the document may be assigned a unique identifier and stored as a record in the e-ticket database 17. To track this document, the transaction database 15 may add one or more rows to the document history table 90, and one or more rows to the FOP table 92, depending on whether any payment events are associated with the document. Using the exemplary transactions depicted in FIG. 3 to demonstrate operation of the document history table 90 and FOP table 92, column 94 of row 112 in document history table 90 may store a unique identifier (e.g., T-001) for document 56. The unique identifier may comprise, for example, a record locator that identifies a record in the e-ticket database 17 where the document 56 is stored. Column 96 of row 112 may store data defining the type of document (e.g., “ticket”), column 98 of row 112 may store data identifying a parent document, if present, and column 100 of row 112 may store data defining the document sub-type, if present.

For the exemplary transaction 55, because document 56 was purchased without exchanging another document, the unique identifier in column 94 of row 112 may be the same as the unique identifier in column 98 of row 112. In other embodiments of the invention, column 98 of row 112 could be left empty if the document does not have a parent. Column 98 of row 112 could also be populated with data indicating that the document identified in column 94 does not have a parent. In any case, a person having ordinary skill in the art would understand that both the syntax and configuration of the document history table 90 and FOP table 92 illustrated by FIG. 4 is for exemplary purposes only, and embodiments of the invention are not limited to the configuration or syntax shown.

The transaction database 15 may begin the process of recording payment event 59 by assigning a payment event number (e.g., PEI-001) to the payment event 59. The payment event number may then be stored in column 102 of newly defined row 114 of the FOP table 92. The transaction database 15 may thereby associate data in row 114 of FOP table 92 with the tracked payment event 59 identified by the payment event identifier PEI-001. Additional data stored in row 114 may include the document identifier for the document associated with the tracked payment event in column 104, data defining the type of transaction in column 106 (e.g., issuance of a document), data defining the form of payment associated with the tracked payment event 59 in column 108 (e.g., credit card A), and data defining an amount of the payment associated with the form of payment in column 110 (e.g., $1,200). In the present example, to document each of the three forms of payment used to pay for document 56, the FOP table 92 may include, in addition to row 114, row 116 to document payment event 57, and row 118 to document payment event 58.

In response to detecting the occurrence of transaction 60, the payment system 14 may cause the transaction database 15 to add rows 120, 122, 124 to the document history table 90, and rows 126, 128 to the FOP table 92. Column 94 of row 120 may store a document identifier (e.g., T-002) that identifies document 62 in the e-ticket database 17, column 96 of row 120 may store data indicating the identified document is a ticket, and column 98 of row 120 may store the document identifier T-001 to indicate that document 56 is the parent of document 62.

Column 94 of row 122 may store a document identifier (e.g., R-001) that identifies the residual value document 64 in the e-ticket database 17, column 96 of row 122 may store data indicating document R-001 is an EMD, column 98 of row 122 may store the document identifier T-001 to indicate that document 56 is the parent of the residual value document 64, and column 100 of row 122 may store data defining the document sub-type as “residual value”.

Column 94 of row 124 may store a document identifier P-001 that identifies the penalty document 68 in the e-ticket database 17, column 96 of row 124 may store data indicating the penalty document 68 is an EMD, column 98 of row 122 may store the document identifier T-001 to indicate that document 56 is the parent of penalty document 68, and column 100 of row 124 may store data defining the document sub-type of penalty document 68 as “exchange penalty”.

In the FOP table 92, column 102 of row 126 may store document identifier PEI-004 identifying payment event 66, column 104 of row 126 may store document identifier R-001 identifying the residual value document 64 in the e-ticket database 17, column 106 of row 126 may store data defining the type of transaction (e.g., a refund), column 108 may store data defining the form of payment for the refund (e.g., credit card A), and column 110 of row 126 may store data defining the amount of the refund (e.g., $400).

Column 102 of row 128 may store payment event identifier PEI-005 identifying payment event 70, column 104 of row 126 may store a document identifier P-001 identifying the penalty document 68 in the e-ticket database 17, column 106 of row 128 may store data defining the type of transaction (e.g., an issuance), column 108 of row 128 may store data defining the form of payment for the refund (e.g., cash), and column 110 of row 128 may store data defining the amount of the refund (e.g., $50).

In response to detecting the occurrence of transaction 72, the payment system 14 may cause the transaction database 15 to add rows 130, 132 to the document history table 90 and rows 134, 136, 138, 140 to the FOP table 92. Column 94 of row 130 may store a document identifier T-003 that identifies document 74 in the e-ticket database 17, column 96 of row 130 may store data indicating document T-003 is a ticket, and column 98 of row 130 may store the document identifier T-002 to indicate that document 62 is the parent of document 74.

Column 94 of row 132 may store a document identifier P-002 that identifies the penalty document 80 in the e-ticket database 17, column 96 of row 132 may store data indicating document P-002 is an EMD, column 98 of row 132 may store the document identifier T-002 to indicate that document 62 is also the parent of penalty document 80, and column 100 of row 132 may store data defining the document sub-type of penalty document 80.

In the FOP table 92, column 102 of row 134 may store document identifier PEI-006 identifying payment event 76, column 104 of row 134 may store document identifier T-003 identifying the document 74 in the e-ticket database 17, column 106 of row 134 may store data defining the type of transaction (e.g., an issuance), column 108 of row 134 may store data defining the form of payment (e.g., credit card A), and column 110 of row 134 may store data defining the amount of the payment (e.g., $300).

Column 102 of row 136 may store payment event identifier PEI-007 identifying payment event 78, column 104 of row 136 may store document identifier T-003 identifying the document 74 in e-ticket database 17, column 106 of row 136 may store data defining the type of transaction (e.g., an issuance), column 108 of row 136 may store data defining the form of payment (e.g., credit card B), and column 110 of row 136 may store data defining the amount of the payment (e.g., $500).

Column 102 of row 138 may store payment event identifier PEI-008 identifying payment event 82, column 104 of row 138 may store document identifier P-002 identifying the penalty document 80 in e-ticket database 17, column 106 of row 138 may store data defining the type of transaction (e.g., an issuance), column 108 of row 138 may store data defining the form of payment (e.g., credit card B), and column 110 of row 138 may store data defining the amount of the payment (e.g., $40).

Column 102 of row 140 may store payment event identifier PEI-009 identifying payment event 84, column 104 of row 140 may store document identifier P-002 identifying the penalty document 80 in e-ticket database 17, column 106 of row 140 may store data defining the type of transaction (e.g., an issuance), column 108 of row 140 may store data defining the form of payment (e.g., voucher), and column 110 of row 140 may store data defining the amount of the payment (e.g., $10)

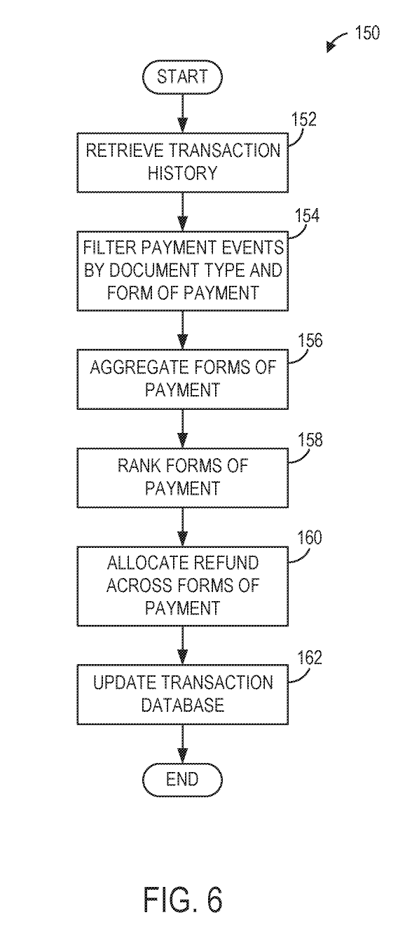

Referring now to FIG. 6, a flowchart depicts a process 150 that may be executed by the payment system 14 in response to receiving a transaction request, such as request to refund or exchange a document. The process 150 may determine a residual value for a document being exchanged or refunded, and how the residual value should be distributed among available forms of payment. The process may start by retrieving the transaction history for the document being refunded. The transaction history may then be used to determine the amounts and forms of payment that are eligible for refunding the document. Once these forms of payment are defined, the payment system may dispense refunds using the eligible forms of payment.

In block 152, the process 150 may retrieve the transaction history for the document being refunded or exchanged from the transaction database 15. The transaction database 15 may, based on an identifier of the document being refunded, identify additional documents related to the document being refunded using the document history table 90. The transaction database 15 may then, based on the identifiers of the related documents, identify payment events using the FOP table 92. The payment system 14 may then assemble the related documents and payment events into a transaction history tree showing relations between and payment events associated with each document. The forms of payment for each document in the transaction history tree may then be filtered and aggregated, and the resulting aggregated forms of payment used to refund the document.

To retrieve the transaction history, the payment system 14 may transmit a query to the transaction database 15. The query may include one or more identifiers that can be used to identify records relating to the transaction history of the document. One such identifier may be the document identifier of the document for which the search history is being requested. In response to receiving the query, the transaction database 15 may use the identifiers to search for related documents and payment events comprising the transaction history of the document. The transaction database 15 may then transmit a reply to the payment system including the search results.

In response to receiving the transaction history from the transaction database 15, the process 150 may proceed to block 154 and filter the payment events comprising the transaction history. This filtering may be based on the type of document and the form of payment associated with the payment event. To this end, the process 150 may extract each form of payment from the payment events in the search results. The process 150 may then filter the extracted forms of payment by applying merchant policies to define a set of payment events that are associated with refund-eligible forms of payment. For example, a merchant may have policies that prohibit refunding payments made to satisfy penalty documents or payment amounts covered by redeeming vouchers. Applying the merchant policies to the extracted forms of payment may result in elimination of any payment events corresponding to an ineligible form of payment (e.g., a voucher), as well as any payment events associated with an ineligible document (e.g., a penalty) regardless of the form of payment.

Merchant policies may also determine how the residual value is distributed to the traveler based on the forms of payment. For example, the process 150 may prioritize refunding a credit card account over making cash payments to the traveler. Applying this exemplary policy of prioritizing credit card payments over cash payment to the filtered forms of payment in table 2 may result in the residual value 64 being refunded to credit card A rather than as a cash payment to the traveler.

Once the forms of payment have been extracted and filtered, the process 150 may proceed to block 156. In block 156, the process 150 may aggregate the forms of payment. Aggregation may comprise summing payment amounts for each payment event in the transaction history involving the same form of payment into a total amount for the aggregate form of payment. Some of the payment events being summed may have a negative value (e.g., a payment event generated by refunding an exchanged document), in which case the sum will reflect the negative value as a reduction in the total amount for the aggregate form of payment.

The process 150 may then proceed to block 158 and rank the aggregated forms of payment based on a refund hierarchy defined by the policies of the merchant. For example, credit card payments may be ranked above cash payments so that residual value documents are reconciled by refunding the corresponding credit card account prior to distributing any cash payments to the traveler. Forms of payment of the same type (e.g., credit card) that are from different sources (e.g., different issuing banks) may be ranked relative to each other based on secondary ranking criteria defined by the merchant. Examples of secondary ranking criteria may include the amount of the aggregated form of payment, the date a payment is due, a time stamp, the identity of the bank that issued the credit card, interest rates, or any other suitable criteria.

Once the forms of payment have been aggregated and ranked, the process 150 may proceed to block 160. In block 160, the process may allocate any refund due to the traveler across the forms of payment. The allocation may begin with the highest ranked aggregated form of payment. If the highest ranked form of payment is exhausted prior to fully reconciling the residual value of the transaction event, the process 150 may proceed down the set of aggregated form of payments to the next ranked aggregated form of payment. This process may continue until the remaining residual value has been refunded, or there are no more eligible forms of payment to draw on. In an alternative embodiment of the invention, the process 150 may propose refunding all, or a portion of, the residual value as a voucher prior to allocating any portion of the residual value to one of the forms of payment. In any case, in response to allocating the residual value, the process may then proceed to block 162 and update the transaction database by causing the transaction database 15 to associate any new payment events with the corresponding tracked documents.

By way of example, the process 150 may be triggered by the exemplary transaction 60 depicted in FIG. 4, which involves the traveler exchanging document 56 for document 62. At the time of the transaction 60, the transaction history may include payment events 57-59 from the transaction 55. These payment events may be extracted from the transaction history, as illustrated by table 1.

TABLE 1
EXTRACTED PAYMENT EVENTS

| Payment Event | Form of Payment | Amount | Document |
|---|---|---|---|
| 57 | Voucher | $400 | Ticket 56 |
| 58 | Cash | $400 | Ticket 56 |
| 59 | Credit Card A | $1200 | Ticket 56 |

Filtering the forms of payment in table 1 by applying the policies of the merchant may eliminate one or more payment events due to a violation of either a form of payment restriction or the allowed type of document. For example, payment event 57 may be ineligible for a refund due to the form of payment being a voucher. Filtering the payment events 57-59 by applying the policies of the merchant may therefore eliminate payment event 57 from consideration, resulting in the filtered payment events shown in table 2.

TABLE 2
FILTERED PAYMENT EVENTS

| Payment Event | Form of Payment | Amount | Document |
|---|---|---|---|
| 58 | Cash | $400 | Ticket 56 |
| 59 | Credit Card A | $1200 | Ticket 56 |

For cases like the one illustrated in table 2 where there is only one payment event for each of the remaining forms of payment, the step of aggregating the forms of payment may leave the content of the filtered payment events unaltered. Thus, if each form of payment in the set of filtered payment events is associated with only a single payment event, the aggregation step may be skipped, or if applied, may fail to alter the set of the filtered payment events.

Ranking the aggregated payment events in accordance with the exemplary merchant policies described above may order the aggregated forms of payment with payments using credit cards ranked above cash, as in as shown in table 3.

TABLE 3
RANKED AGGREGATED FORMS OF PAYMENT

| Form of Payment | Amount |
|---|---|
| Credit Card A | $1200 |
| Cash | $400 |

The process 150 may first attempt to reconcile the residual value document using the highest ranked form of payment, e.g., credit card A. Because the residual value document 64 in the present example can be reconciled by refunding a value less than the amount of the highest ranking form of payment, the process may reconcile the residual value document 64 by refunding this amount (e.g., $400) to the highest ranking form of payment (e.g., credit card A). To document the transaction history of transaction 60, the process may update the transaction database 15 by storing records that define each of refund payment event 66 and penalty payment event 70.

Applying the process 150 to a refund of document 74, the set of payment events extracted from the transaction history may be illustrated by table 4. The set of extracted payment events illustrated in table 4 may include the payment events from table 1 as well as the additional payment events occurring in transaction 60 and transaction 72. That is, the transaction history stored in the transaction database 15 may be cumulative.

TABLE 4
EXTRACTED PAYMENT EVENTS

| Payment Event | Form of Payment | Amount | Document |
|---|---|---|---|
| 57 | Voucher | $400 | Ticket 56 |
| 58 | Cash | $400 | Ticket 56 |
| 59 | Credit Card A | $1200 | Ticket 56 |
| 66 | Credit Card A | −$400 | Residual Value 64 |
| 70 | Cash | $50 | Penalty 68 |
| 76 | Credit Card A | $300 | Ticket 74 |
| 78 | Credit Card B | $500 | Ticket 74 |
| 82 | Credit Card B | $40 | Penalty 80 |
| 84 | Voucher | $10 | Penalty 80 |

Filtering the set of extracted payment events in table 4 to remove non-refundable forms of payment and non-refundable types of documents may produce the refund-eligible set of payment events illustrated in table 5.

TABLE 5
REFUND-ELIGIBLE PAYMENT EVENTS

| Payment Event | Form of Payment | Amount | Document |
|---|---|---|---|
| 58 | Cash | $400 | Ticket 56 |
| 59 | Credit Card A | $1200 | Ticket 56 |
| 66 | Credit Card A | −$400 | Residual Value 64 |
| 76 | Credit Card A | $300 | Ticket 74 |
| 78 | Credit Card B | $500 | Ticket 74 |

Aggregating the forms of payment in set of refund-eligible payment events in table 5 may include summing the refund-eligible amounts associated with Credit Card A ($1,200+$300-$400), which produces a total refund-eligible amount of $1,100 for that form of payment. The aggregated forms of payment may then be ranked based on the primary criteria (e.g., form of payment type, with credit cards ranking higher than cash) and secondary criteria (e.g., the total refund-eligible amount) to produce the set of aggregated eligible forms of payment. An exemplary set of ranked aggregated forms of payment is shown in table 6.

TABLE 6
RANKED AGGREGATED FORMS OF PAYMENT

| Form of Payment | Amount |
|---|---|
| Credit Card A | $1,100 |
| Credit Card B | $500 |
| Cash | $400 |

The process may then allocate refunded monies to the refund-eligible forms of payment in their ranked order up to the residual amount. In the present example, refunding the account associated with the highest ranking form of payment with the corresponding available amount fails to fully refund the amount of the document 74, e.g., $2,400-$1,100=$1,300. If the available amount for the highest ranking aggregated form of payment is insufficient to cover the price of the document, the process 150 may select the next highest ranked form of payment in the set (e.g., credit card B), and apply the available amount toward the balance of the price of the document 74. In the present example, the amount of refund-eligible funds available for the next highest ranking form of payment (e.g., credit card B) is less than remaining un-refunded amount of the document 74, so the entire amount is credited, resulting in a remaining un-refunded balance of $1,300-$500=$800.

The process of selecting the next highest ranked form of payment and applying the available amount to the price of the document may continue until all available amounts are exhausted, or until the full price of the document has been refunded. In the present example, the process 150 may apply the next available form of payment (e.g., cash) to the un-refunded balance of document 74. This may leave an un-refunded balance of $800-$400=$400, which may represent an unrecoverable amount due to the eligible forms of payment being exhausted.

In an embodiment of the invention, there may be a maximum number N of forms of payment that can accept refunds from a single document. In this case, it may be necessary to refund a greater than aggregate amount to one of the forms of payment. By way of example, in an embodiment of the invention, a request for a refund may produce a residual value document having a value of $300. If the first three forms of payment in the example, credit card A, credit card B, and credit card C, have aggregate values of $100, $50, and $80 respectively, and the merchant has a rule setting N=3, the total refund would be $70 short if the rules were strictly adhered to. In this case, the payment system 14 may simply add an extra $70 to the lowest priority form of payment, in which case the refunded amount to credit card C would be $80+$70=$150. In an alternative embodiment of the invention, rather than increasing the refunded amount to one of the forms of payment, the payment system could replace the third form of payment with an alternative form of payment, such as an e-bank voucher for the remainder of the refund amount, e.g., $150.

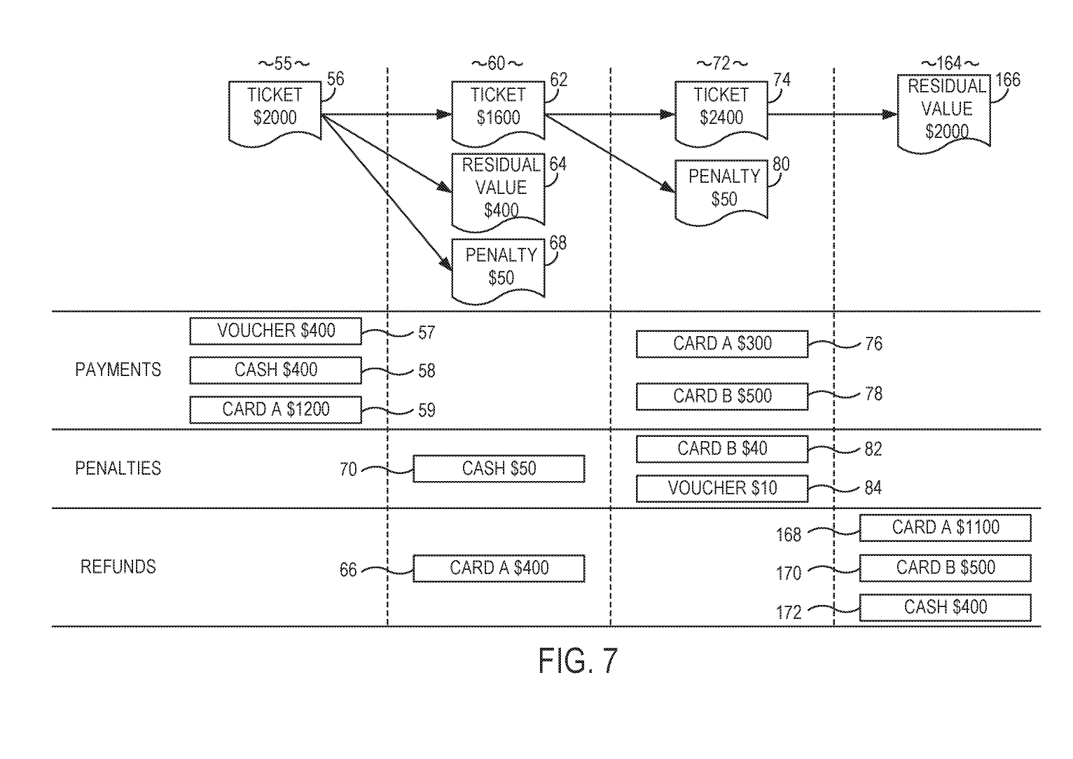

Referring now to FIG. 7, having exhausted all eligible forms of payment, the process 150 may record a transaction event 164 by storing a residual value document 166 in the transaction database 15. The payment system 14 may also store payment events 168, 170, 172 in the transaction database 15 to document how the residual amount document was reconciled across the forms of payment.

The payment system 14 may be used by a traveler or merchant, such as a travel agent, to calculate refund amounts and exchange documents. Another potential user may include a third party to the transaction, such as a payment service provider. Payment service providers may include entities, such as financial institutions, that are responsible for integrity of funds available through a given form of payment belonging to the customer. For example, the issuing bank for a credit card may be responsible for misuse of the credit card, and may approve or deny debiting of the account to prevent misuse.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within that it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatus, or other devices to function in a particular manner, such that the instructions stored in the computer-readable medium produce an article of manufacture including instructions that implement the functions, acts, and/or operations specified in the flow-charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-charts, sequence diagrams, and/or block diagrams may be re-ordered, processed serially, and/or processed concurrently consistent with embodiments of the invention. Moreover, any of the flow-charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system for processing transaction requests, the system comprising:
one or more processors; and
a memory coupled to the one or more processors, the memory storing data comprising a database and program code that, when executed by the one or more processors, causes the system to:
in response to receiving a transaction request for a first document, retrieve a transaction history for the first document from the database, the transaction history comprising a plurality of payment events each associated with a form of payment;
filter the plurality of payment events to determine a set of payment events associated with forms of payment that are refund-eligible;
aggregate the forms of payment associated with the set of payment events to produce one or more aggregated forms of payment;
rank the one or more aggregated forms of payment based on a refund hierarchy;
select a first aggregated form of payment from the one or more aggregated forms of payment based on rank; and
determine a first amount to be refunded to the first aggregated form of payment based at least in part on a residual value of the first document.

2. The system of claim 1 wherein each form of payment is of a respective type and a respective amount, and the one or more aggregated forms of payment are ranked based at least in part on the respective type or the respective amount.

3. The system of claim 1, wherein each form of payment is of a respective type, and the program code causes the system to filter the plurality of payment events to determine the set of payment events by:
removing at least one payment event associated with a form of payment that is not of a refund-eligible type.

4. The system of claim 1, wherein each of the plurality of payment events is associated with a document having a respective type, and the payment events are filtered to determine the set of payment events associated with the forms of payment that are refund-eligible based at least in part on the respective type of document associated with each payment event.

5. The system of claim 1, wherein the plurality of payment events includes a first payment event associated with the first document and a second payment event associated with a second document that was exchanged for the first document.

6. The system of claim 1, wherein each payment event comprises a second amount of the associated form of payment, the associated form of payment is of a respective type, and the program code causes the system to aggregate the forms of payment by:
for each respective type, summing the second amounts to produce an aggregated form of payment of the respective type.

7. The system of claim 1 wherein the first aggregated form of payment is of a second amount, and the residual value is of a third amount, and the program code further causes the system to:
in response to the second amount being less than the third amount, refunding the second amount to the first aggregated form of payment; and
select a second aggregated form of payment from the one or more aggregated forms of payment based on rank; and
determine a fourth amount to be refunded to the second aggregated form of payment based at least in part on a remaining residual value for the first document.

8. A method of processing a transaction request for a first document, the method comprising:
in response to receiving the transaction request, retrieving, by a computer, a transaction history for the first document from a database, the transaction history comprising a plurality of payment events each associated with a form of payment;
filtering, by the computer, the plurality of payment events to determine a set of payment events associated with forms of payment that are refund-eligible;
aggregating, by the computer, the forms of payment associated with the set of payment events to produce one or more aggregated forms of payment;
ranking, by the computer, the one or more aggregated forms of payment based on a refund hierarchy;
selecting a first aggregated form of payment from the one or more aggregated forms of payment based on rank; and
determining, by the computer, a first amount to be refunded to the first aggregated form of payment based at least in part on a residual value of the first document.

9. The method of claim 8, wherein each form of payment is of a respective type.

10. The method of claim 9 wherein the respective type of each form of payment is a credit card type, a voucher type, a cash type, or a points type.

11. The method of claim 9, wherein each of the one or more aggregated forms of payment is of a respective amount, and the one or more aggregated forms of payment are ranked based at least in part on the respective type or the respective amount.

12. The method of claim 9, wherein filtering the plurality of payment events to determine the set of payment events associated with the forms of payment that are refund-eligible comprises:
removing at least one payment event based on the respective type of the associated form of payment.

13. The method of claim 8, wherein each of the plurality of payment events is associated with a document having a respective type, and the payment events are filtered to determine the set of payment events associated with the forms of payment that are refund-eligible based at least in part on the respective type of document associated with each payment event.

14. The method of claim 8, wherein the plurality of payment events includes a first payment event associated with the first document and a second payment event associated with a second document that was exchanged for the first document.

15. The method of claim 8, wherein each payment event comprises a second amount of the associated form of payment, the associated form of payment is of a respective type, and further comprising:
for each respective type, summing the second amounts to produce an aggregated form of payment of the respective type.

16. The method of claim 8 wherein the first document is one of a plurality of related documents, and each payment event is associated with one of the plurality of related documents.

17. The method of claim 8 wherein the first aggregated form of payment is of a second amount, and the residual value is of a third amount, and further comprising:
in response to the second amount being less than the third amount, refunding the second amount to the first aggregated form of payment; and
selecting a second aggregated form of payment from the one or more aggregated forms of payment based on rank; and
determining a fourth amount to be refunded to the second aggregated form of payment based at least in part on a remaining residual value for the first document.

18. The method of claim 17 wherein the first aggregated form of payment is a highest ranked aggregated form of payment, and the second aggregated form of payment is a next highest ranked aggregated form of payment.

19. The method of claim 8 wherein the transaction request is to exchange the first document for a second document, and further comprising:
storing a new payment event in the database, the new payment event having a value equal to the first amount; and
associating the new payment event with the second document in a first table of the database.

20. A computer program product for processing transaction requests, the computer program product comprising:
a non-transitory computer-readable storage medium; and
program code stored on the non-transitory computer-readable storage medium that, when executed by one or more processors, causes the one or more processors to:
in response to receiving a transaction request for a document, retrieve a transaction history for the document from a database, the transaction history comprising a plurality of payment events each associated with a form of payment;
filter the plurality of payment events to determine a set of payment events associated with forms of payment that are refund-eligible;
aggregate the forms of payment associated with the set of payment events to produce one or more aggregated forms of payment;
rank the one or more aggregated forms of payment based on a refund hierarchy;
select an aggregated form of payment from the one or more aggregated forms of payment based on rank; and
determine an amount to be refunded to the aggregated form of payment based at least in part on a residual value of the document.
